(19) United States
(12) Patent Application Publication
(10) Pub. No.: US 2018/0041029 A1
(43) Pub. Date: Feb. 8, 2018

(54) UNDERWATER VEHICLE COMPRISING POWER STORAGE SOURCES MADE FROM LITHIUM-ION BATTERIES

(71) Applicant: DCNS, Paris (FR)

(72) Inventors: Bernard KERUEL, PLOUGASTEL DAOULAS (FR); Nicolas PIERRE, QUIMPER (FR)

(21) Appl. No.: 15/318,588

(22) PCT Filed: Jun. 10, 2015
(86) PCT No.: PCT/EP2015/062966

§ 371 Date: Dec. 30, 2016

(30) Foreign Application Priority Data
Jun. 13, 2014 (FR) 14/01348

(51) Int. Cl. H02J 1/10; H02J 7/00; H02J 1/08; B63G 8/00

(52) U.S. Cl. CPC H02J 1/108; B63G 8/00; H02J 7/0068; H02J 1/08

(57) ABSTRACT

An underwater vehicle includes an on board power grid, the power grid including powerlines, a plurality of DC energy storage sources based on lithium-ion batteries, each source having a positive terminal and a negative terminal, and being connected on the one hand to a charger and on the other hand to energy consumers of the vehicle, one of the terminals of each source being connected to a first powerline of the power grid, the other terminal of each source being connected on the one hand by a second powerline of the power grid to the charger through one-way semiconductor conducting unit and on the other hand by a third powerline of the electric grid to consumers through one-way semiconductor conducting unit.

The present invention relates to an underwater vehicle such as a submarine strictly speaking.

These types of underwater vehicles are provided with electrical propulsion means powered from a power grid.

As a general rule, for safety reasons, the onboard power grid is cut into boards.

These types of underwater vehicles also have a large quantity of DC power storage sources on board.

Due to their low mass, lithium-ion batteries make it possible to consider having a large storage capacity on board the vehicle.

However, in the case of a battery architecture where batteries or sets of batteries having the same expected voltage are placed in parallel to form all of the storage means and thus reach the expected capacity, voltage sources are placed in parallel that may deplete one another in particular in case of short-circuit upstream from the power supply board of the grid.

This then imposes major stresses on the protective members of the assemblies, which must be sized relative to the number of assemblies in parallel.

Furthermore, risks of premature aging of these batteries may also be observed, in particular when a permanent so-called floating charge is applied to them.

The invention therefore aims to resolve these problems.

To that end, the invention relates to an underwater vehicle, comprising:

an on board power grid, the power grid comprising powerlines,

a plurality of DC energy storage sources based on lithium-ion batteries, each source having a positive terminal and a negative terminal, and being connected on the one hand to charging means and on the other hand to energy consumers of the vehicle, one of the terminals of each source being connected to a first powerline of the power grid, the other terminal of each source being connected on the one hand by a second powerline of the power grid to the charging means through one-way semiconductor conducting means and on the other hand by a third powerline of the electric grid to consumers through one-way semiconductor conducting means.

According to other features considered alone or in combination, the underwater vehicle according to the invention may also include one or more of the following features:
the one-way semiconductor conducting means comprise diodes;
the terminal of the sources connected to the first powerline of the power grid is the negative terminal of the sources;
circuit breakers are provided in the power grid.

The invention will be better understood using the following description, provided solely as an example and done in reference to the appended drawings, in which:

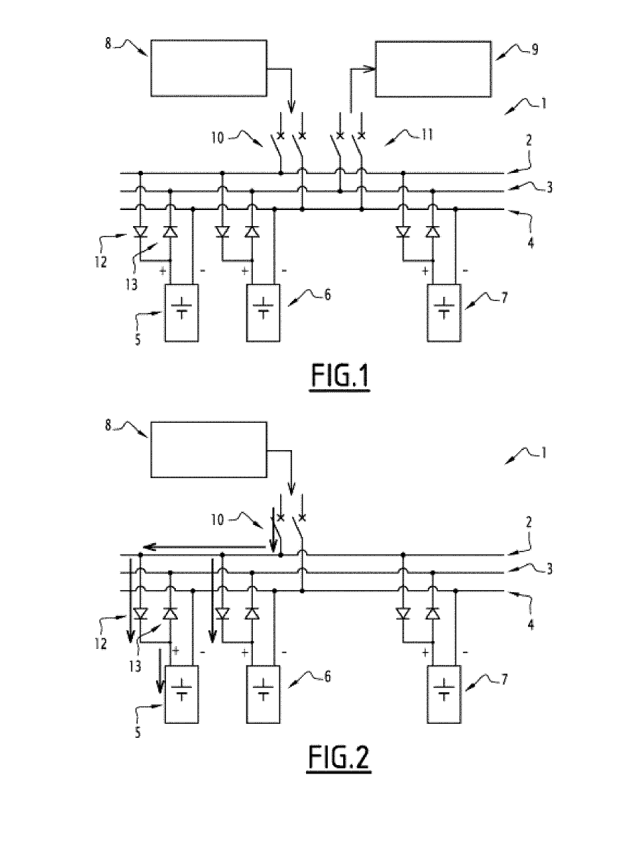

FIG. 1 shows a block diagram illustrating the structure of an onboard power grid of an underwater vehicle according to the invention, and

FIGS. 2, 3, 4, 5, 6, 7 and 8 illustrate the operation of such a grid in different possible operating configurations.

In the figures, and in particular in FIG. 1, an on board power grid 1 of an underwater vehicle such as a submarine is illustrated.

This grid includes powerlines, for example three powerlines respectively designated by references 2, 3, 4.

The underwater vehicle also includes a plurality of DC power storage sources made from lithium-ion batteries In the example embodiment illustrated in FIG. 1, three sources 5, 6, 7 are shown.

Each source has a positive terminal and a negative terminal and is connected on the one hand to charging means 8 and on the other hand to power consumers 9 of the vehicle via circuit breakers 10 and 11, respectively.

Indeed, and as illustrated, the charging means 8 are connected between the lines 2 and 4 of the power grid 1. These lines 2 and 4 are also connected to the positive and negative terminals, respectively, of the sources 5, 6, 7.

In particular, the line 2 is connected to the positive terminal of the source 5, for example through one-way semiconductor conducting means 12 mounted in the on direction.

The consumers 9 are in turn connected between the lines 3 and 4 of the power grid 1. As illustrated, the positive terminal of the batteries is also connected to the line 3 of the grid, for example through one-way semiconductor conducting means 13 mounted in the on direction.

Thus, different circuits are used depending on whether the batteries are charging or discharging so as to be able to implement protection means 12, 13 easily at the head of the sources 5, 6, 7 without having to use controlled switches.

These means 12, 13 are for example diodes.

Owing to a distribution on three powerlines, the diodes 12, 13 at the head of the sources 5, 6, 7 passively, i.e., in a non-controlled manner, impose the power transfer direction between the sources 5, 6, 7 and the consumer grid 9 or between the charging means 8 and them, depending on whether one is discharging or charging.

Thus for example and as illustrated in FIG. 2 by bold arrows, when the sources 5, 6, 7 are charging, power coming from the charging means 8 is contributed to these sources 5, 6, 7 while passing through the corresponding diodes 12.

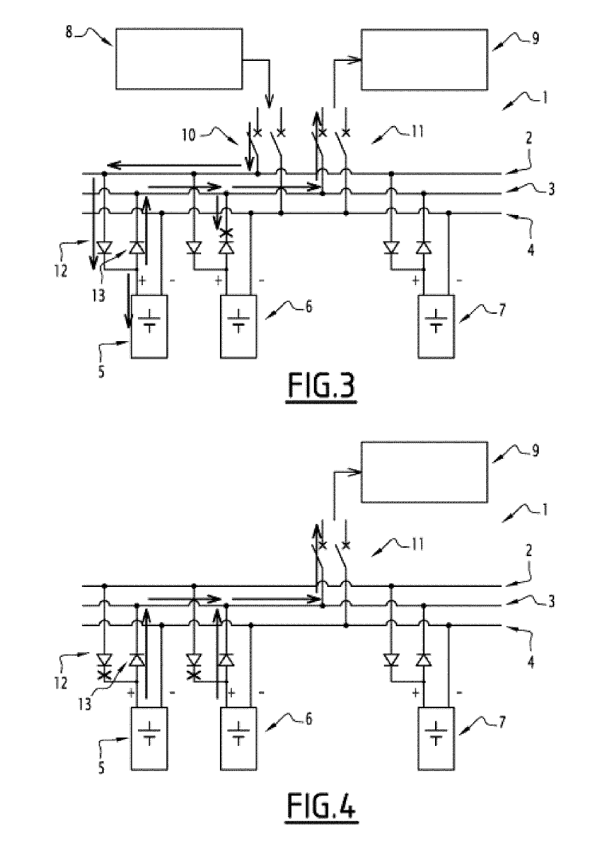

As illustrated in FIG. 3, power can also be provided to the consumers 9 while recharging the batteries of the sources 5, 6, 7, as is currently the case with traditional batteries. Conversely, the energy does not discharge from one set of batteries to another due to the diodes 13 mounted with non-return, for example.

As illustrated in FIG. 4, during discharge, the set of batteries from the sources 5, 6, 7 delivers power through diodes 13 mounted in the on direction, from the sources 5, 6, 7.

Conversely and as illustrated in FIG. 5, a set of batteries of a source 5, 6, 7 may only be recharged by the charging means 8 and not by sets of batteries from other sources 5, 6, 7 discharging therein.

This situation could be encountered in case of short-circuit at the assembly in question or in case of weakness of this assembly relative to the other assemblies, for example weakness due to a voltage lower than that of the other assemblies.

If a short-circuit or a weakness appears at one source 5, 6, 7 during discharging, the other sources 5, 6, 7 cannot discharge therein because it is blocked by the diodes 13 connected to the discharging circuit and by protective members such as fuses sized independently of the number of sources 5, 6, 7 in parallel, and which are therefore smaller.

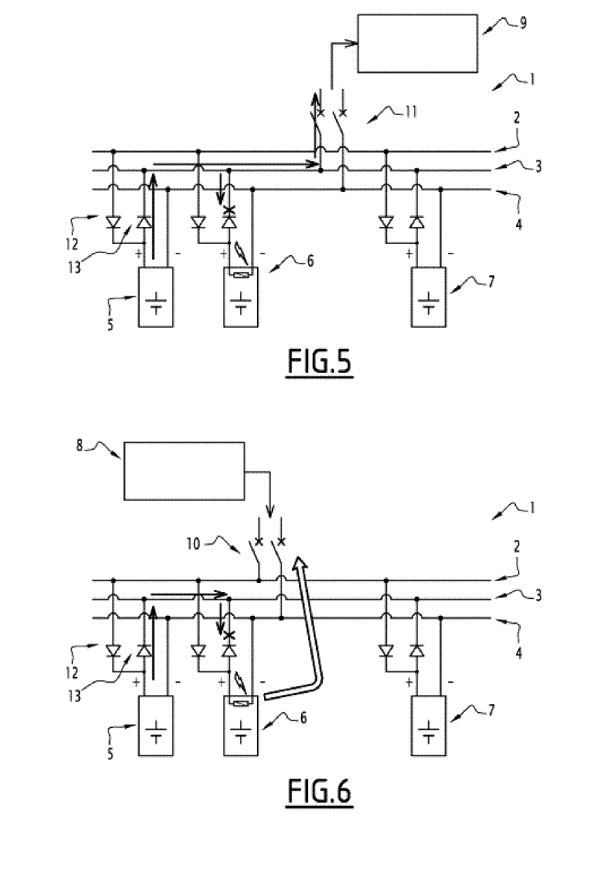

This is for example illustrated in FIGS. 5 and 6.

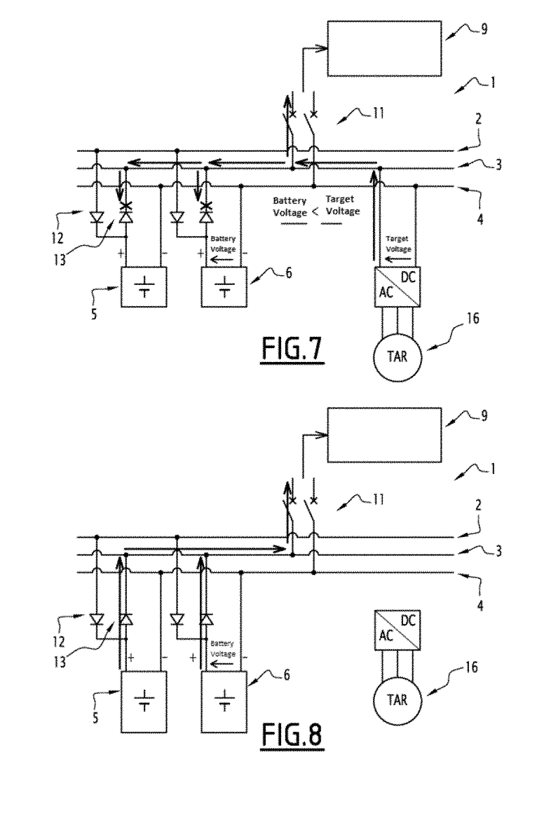

Another advantage of this power grid is illustrated in FIGS. 7 and 8.

Indeed, owing to the use of diodes 12, 13 at the head of battery assemblies, it is possible to consider keeping the batteries of the sources 5, 6, 7 at a high charge level while ensuring that they are available instantaneously.

Thus, the same function is performed as in the floating mode, but without continuously recharging the battery and therefore without risking causing premature aging thereof.

This is possible owing to the low auto-discharge of a lithium-ion battery and the fact that the sources 5, 6, 7 cannot discharge into one another.

Indeed, for a source 5, 6, 7 not to discharge toward power consumers 9 of the vehicle, it suffices for its fully-charged voltage to be slightly lower than the DC voltage of the consumers 9.

Thus, when another source 16 is working, its voltage higher than that of each of the sources 5, 6, 7 prevents the sources 5, 6, 7 from discharging toward the consumers 9 as long as the diodes 13 prevent this source 16 from recharging the battery.

If the source 16 is lost, the voltage of this source 16 drops below that of the sources 5, 6, 7, which then naturally take over supplying power for the consumers 9.

The natural switching owing to the diodes 12, 13 is illustrated in FIG. 8.

Thus, the present invention makes it possible to protect the battery assemblies against untimely discharges, simplify the sizing of the protective members for these assemblies, and make it possible to have a battery behavior equivalent to that which it would have had in the floating mode without the drawbacks of said floating mode, all naturally owing to the diodes 12, 13, which do not require any specific control.

Of course, other embodiments may also be considered.

1-4. (canceled)

5. An underwater vehicle, comprising:
an on board power grid, the power grid comprising powerlines,
a plurality of DC energy storage sources based on lithium-ion batteries, each source having a positive terminal and a negative terminal, and being connected on the one hand to charging means and on the other hand to energy consumers of the vehicle, one of the terminals of each source being connected to a first powerline of the power grid, the other terminal of each source being connected on the one hand by a second powerline of the power grid to the charging means through one-way semiconductor conducting means and on the other hand by a third powerline of the electric grid to consumers through one-way semiconductor conducting means.

6. The underwater vehicle according to claim 5, wherein the one-way semiconductor conducting means comprise diodes.

7. The underwater vehicle according to claim 5, wherein the terminal of the sources connected to the first powerline of the power grid is the negative terminal of the sources.

8. The underwater vehicle according to claim 5, wherein circuit breakers are provided in the electric grid.

9. The underwater vehicle according to claim 6, wherein the terminal of the sources connected to the first powerline of the power grid is the negative terminal of the sources.
